(19) United States
(12) Patent Application Publication
(10) Pub. No.: US 2014/0188744 A1
(43) Pub. Date: Jul. 3, 2014

(54) METHOD AND SYSTEM FOR COLLECTING, MANAGING, ANALYZING, VERIFYING AND SHARING AN INDIVIDUAL'S PERSONAL AND/OR PROFESSIONAL REFERENCES

(71) Applicant: MyInput.com, Inc., Seattle, WA (US)

(72) Inventor: Alan Nazarelli, Seattle, WA (US)

(73) Assignee: MyInput.com, Inc., Seattle, WA (US)

(21) Appl. No.: 14/139,028

(22) Filed: Dec. 23, 2013

Related U.S. Application Data
(60) Provisional application No. 61/746,490, filed on Dec. 27, 2012.

(51) Int. Cl. G06Q 50/26; G06Q 10/00

(52) U.S. Cl. CPC G06Q 50/265; G06Q 10/00
USPC 705/325

(57) ABSTRACT

Systems and methods for electronically managing the process of requesting, giving, and receiving personal references are provided. Personal information, particularly contact information, is received by a computer system from a candidate seeking a personal reference. Some of this information is forwarded to a personal reference giver to request that a personal reference regarding the candidate be given. The personal reference information is received by the computer system. The candidate and reference giver may access the personal received personal reference information. The personal reference information can then be sent to a recipient. The candidate and reference giver can be contacted when the recipient has accessed, reviewed, or modified the personal reference information. Access to the personal information of the candidate and the personal reference information from the personal reference giver can be based on a comparison with a set of rules and permissions.

### CROSS-REFERENCE

This application claims the benefit of U.S. Provisional Application No. 61/746,490, filed Dec. 27, 2012, which application is incorporated herein by reference.

### BACKGROUND OF THE INVENTION

1. Field of the Invention

The present disclosure relates to systems and methods for gathering, managing, analyzing, and verifying for various purposes information or data relating to an individual's personal and/or professional references. More particularly, the present disclosure relates to methods in which gathered data is compared to a set of rules, permissions, and publicly and privately provided data so that the data can be more easily collected, reviewed, shared amongst, and evaluated by various users.

2. Background

Personal and professional references are used for many purposes. Job seekers, college or university applicants, private or public club members, government bidders or contractors, etc. would all have reasons to provide, from time to time, one or more personal references at the request of an individual, corporation, or private or public institution. Many application processes, such as job applications and college or university entrance applications, have been automated through the use of various online services, for example, in the case of employment, job boards, and online recruiting web sites, and in the case of educational institutions, online application processing web sites. Applicants can search for various opportunities online, create and send applications online, post resumes and personal information online, and track communication and the results of their applications.

There remains, however, a weak link in the online functionality of these application and opportunity web sites and processes for the participants—the management and confirmation of personal references. The processes of an application candidate contacting and seeking permission from a personal reference giver prior to an interview, the personal reference giver giving that permission, and then a reviewer confirming the validity of, reviewing information on, and contacting those references pre or post interview are still clumsy and analog.

Accordingly, there are needs for systems and methods that gather and store publicly available and privately provided personal and professional data regarding the participants in the personal reference giving process, compare the data to a set of rules and permissions, and then give such participants the ability to automatically review, amend, share, track, and comment on the data for the purposes of making the entire referencing process faster, more dependable, more accurate, and more secure.

### SUMMARY OF THE INVENTION

The present disclosure provides systems and methods for gathering, giving, receiving, managing, analyzing, verifying, and/or disseminating for various purposes information or data relating to an individual's personal and/or professional references. More particularly, the present disclosure relates to methods in which gathered data is compared to a set of rules, permissions, and publicly and privately provided data so that the data can be more easily collected, stored, reviewed, shared amongst, and evaluated by various users.

Many aspects of the present disclosure can be used by various users. Such users can be divided into categories of user groups, including “Candidates,” “Givers,” and “Receivers” who are collectively referred to herein as the “Participants.” According to many embodiments, information provided directly by the Participants and/or information regarding the Participants that is gathered from public or private sources can be compared to a set of rules and permissions to better allow the Participants to manage and share information and efficiently communicate. A participant may include an individual selected from a group comprising: an individual seeking employment, an individual seeking membership in an organization, an individual seeking enrollment in an educational institution, an individual seeking inclusion or participation in a group of people, an individual seeking a clearance or a type of clearance to qualify for certain jobs or tasks, an individual seeking one or more privileges such as the privilege to apply to a club or to rent an apartment, and an individual or an entity desiring or needing to qualify for or to be favorably considered for certain jobs, projects, or assignments.

As used herein, the term “Candidate” includes one or more individuals seeking employment, membership, enrollment, or other forms of inclusion or participation in a private or public corporation, organization, educational institution, club, or the like for which a reference regarding the Candidate's bona fides is being offered by the Candidate or request by others.

As used herein, the term “Giver” refers to a reference giver, who is an individual providing a reference or confirmation regarding the Candidate.

As used herein, the term “Receiver” refers to a reference receiver, who is an individual, corporation, institution, organization, or the like to whom the Candidate is providing the reference either by request of the Receiver or as offered by the Candidate.

The present disclosure provides systems and methods that may: gather and store information (or data) provided by a Candidate; gather and store information (or data) regarding the Candidate that is collected using web search processes; and/or compare any of the provided or collected information data against a set of rules and/or permissions which, based upon the information, allows the Candidate to securely store and access at least a portion of the provided or collected information.

The present disclosure also provides systems and methods that may: gather and store information regarding the Candidate; have any of the related characteristics described herein; and/or be adapted to further contact and share with a Giver the data and request from the Giver permission to use the Giver as a reference.

The present disclosure also provides systems and methods that may: gather, store, and share information regarding the Candidate; have any of the related characteristics described herein; and/or be further adapted to allow the Giver to complete an electronic questionnaire regarding the Giver's relationship, experience and evaluation of the Candidate thereby providing a reference for the Candidate. Such systems and methods may further allow the Giver to set certain permissions and rules regarding the Candidate's use of the reference which, based upon the information or data, allows the Giver and Candidate to securely store and access at least a portion of the data.

The present disclosure also provides systems and methods that may: gather, store, and share data regarding the Candidate and Giver; have any of the related characteristics described herein; and/or may be further adapted to allow a Receiver, upon being granted access (or permission) by the Candidate to the processor and storage device (also referred to as data storage unit), to review the data for the purpose of evaluating the Candidate and Giver. Such access to the processor and/or storage device may be granted through the provision of a link, a URL, an access code, a mobile telecommunications application, or other means of access to the processor and/or the storage device.

The storage device may comprise at least one of the following: a computer hard drive, random access memory, a computer system, or a database implemented on a computer, a server, or a network of computers.

The present disclosure also provides systems and methods that may: gather, store, and share data regarding the Candidate and/or Giver; have any of the related characteristics described herein; and/or further allow the Receiver to evaluate the data and to make notes, rate, rank, or otherwise record private comments to be accessible only by the Receiver. Such systems and methods may, based upon the information or data, allows the Receiver to securely store and access the data.

The present disclosure also provides systems and methods that may: gather, store and share data regarding the Candidate, Giver, and Receiver; have any of the related characteristics described herein; and/or further allow the Receiver to send an interview request to the Giver via a secure, third party mailing system and/or conferencing system, and, during or after the interview evaluate the information provided by the Giver and to make notes, rate, rank, or otherwise record private comments regarding the interview to be accessible only by the Receiver, which, based upon the information or data, allows the Receiver to evaluate the Candidate and to securely store and access the data.

The present disclosure also provides systems and methods that: gather, store, and share information regarding the Candidate, Giver, and Receiver; have any of the related characteristics described herein; and/or that may further automatically notify the Candidate, via electronic mail, text message, telephone call, mobile telecommunications application, or other form of communication when a Receiver has viewed data on a Giver that was provided by the Candidate, has sent an interview request to a Giver and/or has completed and interview with a Giver.

The present disclosure also provides systems and methods that may: gather, store, and share information regarding the Candidate, Giver and/or Receiver; have any of the related characteristics described herein; and/or further automatically notify the Giver, via electronic mail, text message, telephone call, mobile telecommunications application, or other form of communication when a Candidate has sent data on the Giver to a Receiver, when a Receiver has viewed data on the Giver, and/or when the Candidate ceases to require the data provided by the Giver.

The above and other objects of the present disclosure can be achieved in one or more embodiments by providing one or more systems for receiving, collecting, storing and sharing data on the Participants. Such systems can include a processor having a communications connection for receiving the data concerning the Participants and a storage device accessible by the processor, the storage device having stored thereon a set of rules and permissions. The processor can review and/or manipulate the Participant data into processed Participant data, and compares the processed Participant data against the set of rules and permissions in order to verify and rate the processed participant data and confirm that the data complies with the set of rules and permissions.

An aspect of the present disclosure provides systems for gathering, managing, analyzing, and verifying an individual's personal and/or professional references and for notification and sharing of the gathered data. Such systems may comprise a processor configured to receive publically available and/or privately provided data concerning personal and contact information and a purpose requiring a reference. Such data may be provided through the Internet, a cellular network, an intranet, a private intranet, or other wide area or local area network (WAN or LAN), for example. For example, the processor may be configured to upload and/or download such data from one or more of such networks. The processor may be further configured to securely and in an automated fashion notify users when, according to a set of rules and permissions, information is available for review or has been accessed by one of users.

In many embodiments, the systems may further be used to provide the Receiver with privately provided and/or publically available information on a Candidate. The processor may be configured to receive and store data provided by the Candidate, and the Giver, and/or to receive and store data that is automatically collected using internet based search technologies. The Processor may also be configure to receive information about the Candidate and/or the receiver from one or more third party searching services via the Internet and/or private network connections. Such third party searching services may include but are not limited to background checking services, drug testing services, or credit reporting agencies. The systems and methods may further comprise one or more storage devices for storing data accessible by said processor. The storage device may have stored thereon data indicative of a set or rules, and made securely accessible to the Receiver by the Candidate through the provision of a link, URL, access code, mobile telecommunication application or other means to access to the processor.

In many embodiments, the systems and methods may further provide the Candidate with the ability to securely contact a Giver to request permission to forward the Giver's information to a Receiver. The processor can be configured to receive and store data regarding the purpose for the reference request and information on the Candidate. The storage device can be accessible by the processor. The storage device can have stored thereon data indicative of a set or rules, and made securely accessible to the Giver by the Candidate through the provision of a link, URL, access code, mobile telecommunications application or other means to access to the processor.

In many embodiments, the systems and methods may provide the Giver with the ability to securely review information provided by the Candidate, to give or deny permission for the Candidate to use the Giver as a reference and to, if permission is granted by the Giver, complete a qualifying survey regarding the Giver's relationship with and evaluation of the Candidate and to manage said permission through a set of optional commands chosen by the Giver and based on a set of rules and permissions stored on the processor, including notification to the Giver of reference use, the setting of a reference use deadline, notification of change in Candidate's reason for requiring the reference, etc. The processor can be configured to receive and store the above data. The storage device can be accessible by the processor. The storage device can have stored thereon data indicative of a set or rules, and made securely accessible to the Giver by the Candidate through the provision of a link, URL, access code, mobile telecommunications application, or the like to access to the processor.

In many embodiments, the systems and methods may provide the Receiver with the ability to securely review all of the privately provided and publically available information regarding the Candidate and the Giver, to evaluate the information provided and to make notes, rate, rank or otherwise record private comments to be accessible only by the Receiver regarding the evaluation based on a set of rules and permissions stored on the processor. The processor may be configured to receive and store the data outlined above on one or more storage devices. The storage devices may be accessible by the processor and may have stored thereon data indicative of a set or rules, and made securely accessible to the Receiver by the Candidate through the provision of a link, URL, access code, mobile telecommunications application, or other the like to access to the processor.

In many embodiments, the systems and methods may provide the Receiver with the ability to securely contact the Giver via e-mail using a third party e-mail and/or conferencing system whereby the Giver's actual e-mail need not be accessible to the Receiver, for the purpose of interviewing the Giver regarding the Candidate, and to make notes, rate, rank or otherwise record private comments accessible only by the Receiver. The processor may be configured to receive and store data described above on one or more storage devices. The one or more storage devices may be accessible by said processor. The one or more storage device can have stored thereon data indicative of a set of rules and is made securely accessible to the Receiver by the Candidate through the provision of a link, URL, access code, mobile telecommunications application or other means to access to the processor.

In many embodiments, the systems and methods may automatically provide a Candidate with notification by e-mail, text message, telephone call or other form of communication of any instance where the Receiver reviews the Giver's information, contacts the Giver or does not review or contact the Giver within a specified amount of time. The processor can be configured to receive and store data described above on the one or more storage devices. The one or more storage devices may be accessible by the processor. The storage device can have stored thereon data indicative of a set of rules and made securely accessible to the Receiver through the provision of a link, URL, access code, mobile telecommunications application or the like to access to the processor.

In many embodiments, the systems and methods may automatically provide the Giver with notification by e-mail, text message, telephone call or other form of communication of any instance where the Candidate had added or amended the reason for requiring the reference or no longer needs the reference and when the Receiver reviews the Giver's information. The processor can be configured to receive and store data described above on the one or more storage devices. The one or more storage devices can be accessible by the processor. The one or more storage devices can have stored thereon data indicative of a set or rules, and made securely accessible to the Giver through the provision of a link, URL, access code, mobile telecommunications application or other means to access to the processor.

Additional aspects and advantages of the disclosure will become readily apparent to those skilled in this art from the following detailed description, wherein only illustrative embodiments of the present disclosure are shown and described. As will be realized, the present disclosure is capable of other and different exemplary implementations, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the invention are utilized, and the accompanying drawings of which:

FIG. 1 is a block diagram schematically illustrating operation of a system and method in accordance with embodiments of the present disclosure;

FIG. 2 is a flow diagram illustrating operation and access by a Candidate of an embodiment of the system and method shown in FIG. 1;

FIG. 3 is a flow diagram illustrating operation and access by a Giver of yet another embodiment of the system and method shown in FIG. 1;

FIG. 4 is a flow diagram illustrating operation and access by a Receiver of a further embodiment of the system and method shown in FIG. 1; and

FIG. 5 is a block diagram schematically illustrating the use of the systems and methods shown in FIGS. 1-4 as a tool to connect all of the Participants for improved communication, sharing of information and review.

### DETAILED DESCRIPTION OF THE INVENTION

Aspects of the disclosure provide improved methods and systems for managing the process of requesting, giving, collecting, reviewing, and sending personal references. Various aspects of the disclosure described herein may be applied to any of the particular applications set forth below or for any other types of information that may be submitted and reviewed by a variety of users. Aspects of the disclosure may be applied as a standalone system or method, or as part of larger system or method. It shall be understood that different aspects of the disclosure can be appreciated individually, collectively, or in combination with each other.

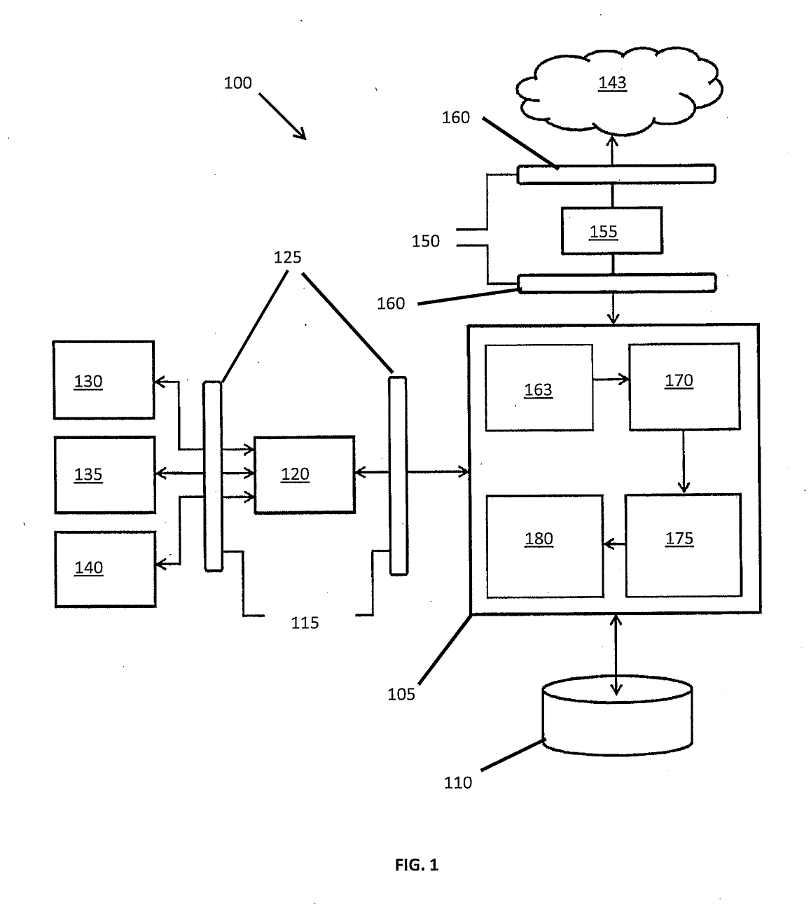

FIG. 1 is a block diagram schematically illustrating operation of a system and method in accordance with embodiments of the present disclosure. The system 100 shown in FIG. 1 comprises a processor 105 and a data storage unit 110. The processor 105 will typically be in electronic communication with the data storage unit 110 to access or store data in the data storage unit 110. The processor 105 may be configured to for many tasks, including collecting data input by the Participants, collecting data regarding the Participants from various Internet sources, comparing all collected data against a set of rules and permissions (which may be set by various Participants as described above), and manipulating the data into specific formats for different Participants for their access, review, and action.

The processor 105 may be in electronic communication with the Participants through a communication connection 115 provided by a first server 120, which may be protected by one or more firewalls 125. The Participants may communicate with the processor 105 of the system using a variety of devices, including a Candidate's computer or mobile device 130, a Giver's computer or mobile device 135, and a Receiver's computer or mobile device 140. The processor may be in electronic communication with another electronic network 143, for example, a wide-area network or the Internet through a communication connection 150 provided by a second server 155, which may be protected by one or more firewalls 160. The processor 105 may perform a collection step 163 comprising a collecting of the data that has been input by the Participants. The processor 105 may be further adapted to perform a collection step 170 comprising a collecting of data regarding the Participants from the electronic network 143, which may comprise various sources including various internet sources. The processor 105 may then perform a comparison step 175 comprising a comparison of the collected data from steps 163 and 170 with a set of rules and permissions thereby facilitating a manipulation step 180 of the collected data into one or more Participant specific formats for access, review and action by the Participants.

FIG. 1 shows the processor 105 connected to the Participant's computers (or mobile devices) 130, 135, and 140 through first server 120 and communication connection 115 as well to network 143 through server 155 and communication connection 150. Network 143 may comprise an Internet network (the Internet). Server 120 may also comprise a web server such that the Participants may communicate with the processor 105 via the Internet. Alternatively, servers 120 and 155 may be the same server and the processor 105 both receives data from the Participants via the Internet and searches the Internet for data related to the Candidate, Giver, or Receiver. In many embodiments, the processor 105 is integrated within a server, typically a web server. The Participants may then access the processor 105 and upload data to said processor 105 via a web page and/or web portal on the internet. The processor 105 may recognize the Participants via login information used by the Participants when accessing the web page or web portal. Participants 105 may then upload data via the web page or web portal. Uploaded data may comprise one or more of the following: recorded statements/interviews, completed web page fields, questionnaires (which may be web pages), computer applications (such a programs designed to administer a test for the Candidate), pdfs, word processing documents, text files, pictures, video, and the like. The processor 105 may then use the login information to store the data uploaded to the processor by the Participants in a correct location of the memory storage device that corresponds to whichever individual Participant up loaded the data in question. Any data related to the Participants or relevant personal references may be stored, access, and manipulated within the server's memory storage (such as a hardrive). In this fashion, storage, access and manipulation of the data related to the Participants may be carried out in a cloud computing environment and access may to said data may be achieved through the Internet by authorized Participants. The server having processor 105 may further comprise a database as its memory storage element or part thereof. The database may be implemented within a computer network in communication with processor 105.

Alternatively or additionally, the server or web server having the processor 105 is accessible through the Internet or a private network connection through an application instead of or in addition to the web page/web portal. The application may be adapted to be installed from computer readable media (optical data storage, hard drive, flash drive, cloud storage, and the like) onto any of the Participant's computers or mobile devices 130, 135, and 140. The installed application may comprise instructions for Participant's computers and mobile devices (which typically have their own processors) to execute in order to facilitate communication of data and alerts between the Participant's and the processor 105.

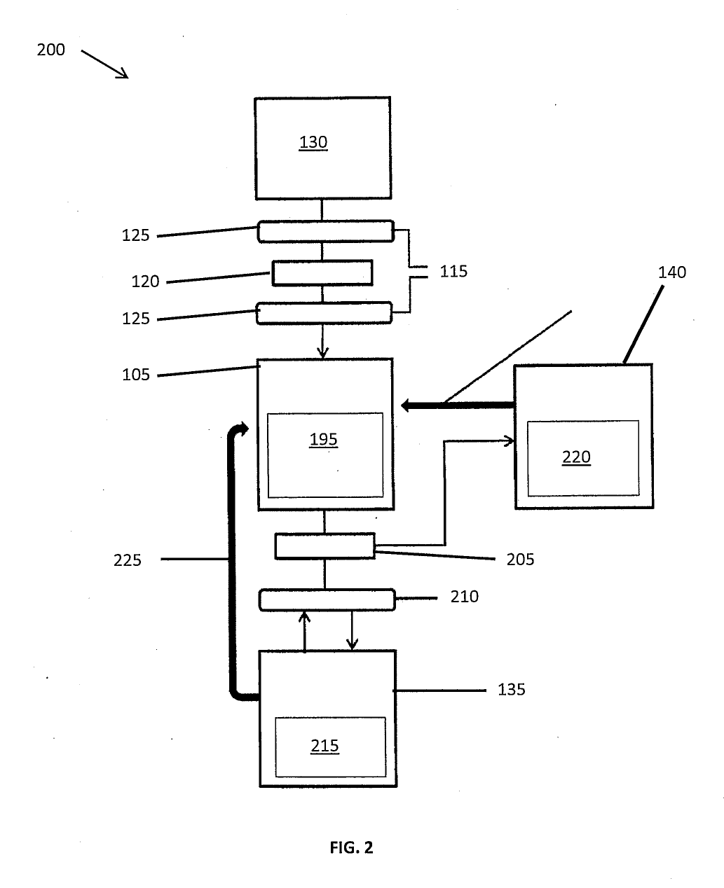

FIG. 2 is a flow diagram illustrating operation and access by a Candidate of a sub-system 200 in accordance with the present disclosure. The system 200 may comprise a component of the system 100 described above with reference to FIG. 1. Through the first server 120 and communication connection 115, the Candidate may accesse the processor 105 through the Candidate's computer or mobile device 130. The Candidate may access the processor 105 for a variety of tasks described above, for example, to upload personal information regarding himself or a prospective personal reference Giver or Receiver, request a personal reference from a Giver, review a personal reference given by a Giver, view status updates regarding the personal reference, set a rule or permission, request that a reference be sent to a Receiver, etc.

On a Candidate “dashboard” 195 provided by the processor 105, the processor 105 can hold and present all input and collected data regarding the Candidate. This dashboard 195 may be accessed by the Candidate's computer or mobile device 130 and also by the Receiver's computer or mobile device 140 if appropriate permissions 220 for such access are given/registered by the Candidate and/or Giver. In at least some cases, the Receiver receives log-in information from the Candidate and/or Giver to access the Candidate “dashboard” 195. Similarly, the dashboard 195 may be accessed by the Giver's computer or mobile device 135 if access permission 215 to the processor is given/registered by the Candidate. In at least some cases, the Giver receives log-in information from the Candidate to access the Candidate “dashboard” 195. The processor 105 may be configured to electronically communicate with an e-mail server 205 to send information to the Giver and/or Receiver's computer or mobile device 135 and/or 140.

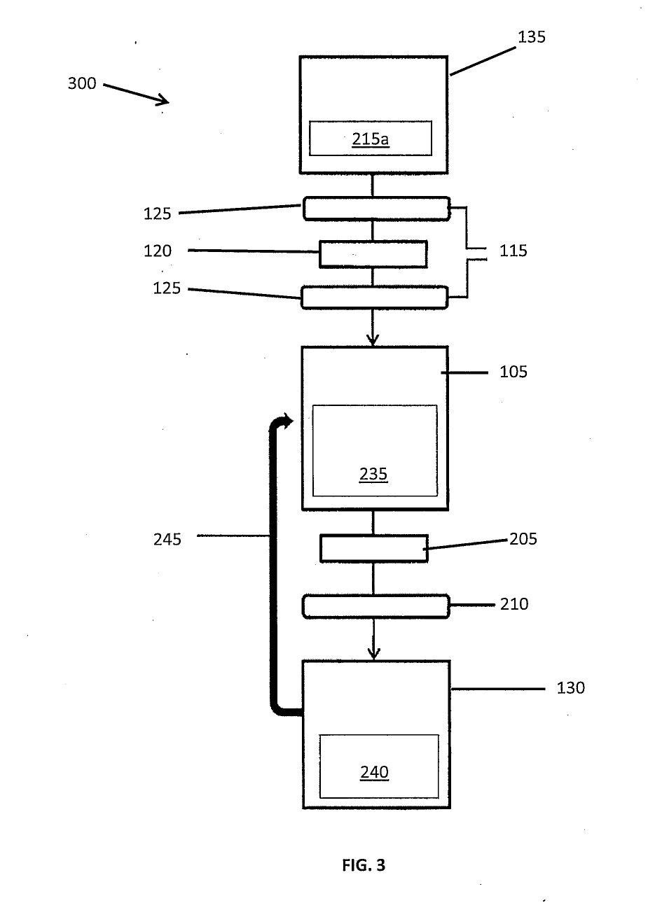

FIG. 3 is a flow diagram illustrating operation and access by a Giver of a sub-system 300 in accordance with the present disclosure. The system 300 may comprise a component of the system 100 described above with reference to FIG. 1. Through the first server and communication connection, the Giver's computer or mobile device 135 can electronically communicate with the processor 105 if access permission 215a is granted by the Candidate. The Giver may access the processor 105 for a variety of tasks described above, for example, to answer a questionnaire or survey regarding the Candidate, to view personal information regarding the Candidate, to upload and/or edit a personal reference regarding the Candidate, view status updates regarding the personal reference, set a rule or permission, etc.

On a Giver “dashboard” 235 provided by the processor 105, the processor 105 can hold and present data provided by or to be provided by the Giver, such as the questionnaire or survey regarding the Candidate, permissions, options, and registration. If permitted access 240 by the Giver, the Candidate can access this Giver “dashboard” 235. The processor 105 may be configured to electronically communicate with an e-mail server 205 to send information, such as information from the Giver “dashboard” 235 to the Candidate.

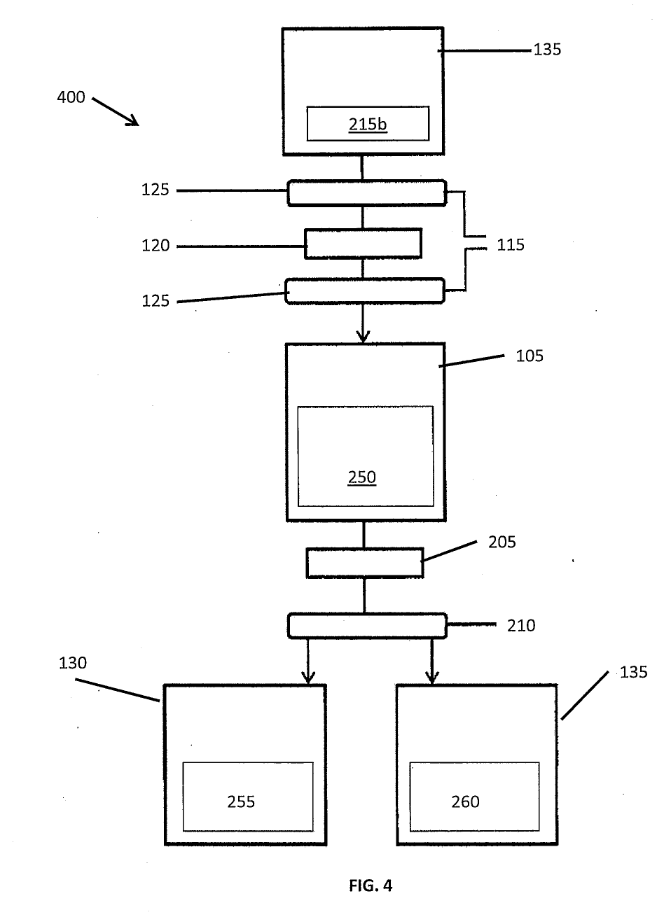

FIG. 4 is a flow diagram illustrating operation and access by a Receiver of a sub-system 400 in accordance with the present disclosure. The system 400 may comprise a component of the system 100 described above with reference to FIG. 1. Through the first server 120 and communication connection 115, the Receiver's computer or mobile device can electronically communicate with the processor if access permission 215b is granted by the Candidate. The Receiver may access the processor 105 for a variety of tasks described above, for example, to access and view the answered questionnaire or survey regarding the Candidate, to view personal information regarding the Candidate, to access and view a personal reference regarding the Candidate, view status updates regarding the personal reference, set a rule or permission, etc.

On a Receiver “dashboard” 250 provided by the processor 105, the processor 105 can hold and present data that is to be provided to the Receiver for review and analysis, such as the Giver and Candidate data discussed above. The processor 105 may be configured to electronically communicate with an e-mail server 205 to send information, such as information from the Receiver “dashboard” 250 to the computer or mobile device 130 or 140 of the Candidate or the Receiver, who may be in ongoing communication with the Receiver.

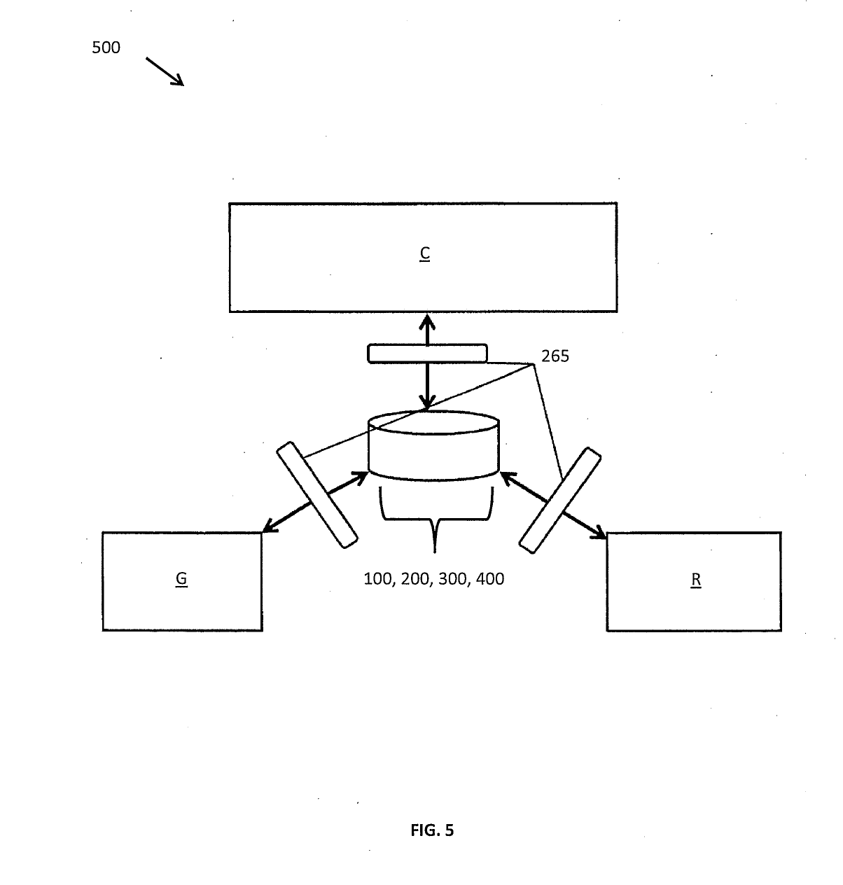

FIG. 5 is a block diagram schematically illustrating the use of the system 100 and sub-systems 200, 300, and 400 and corresponding methods shown in FIGS. 1-4 as a tool to connect all of the Participants for improved communication, sharing of information and review. The system, including the processor and data storage device, can communicate with Candidates C, Givers G, and Receivers R through a number of different communications connections 265. With this system and associated methods, the process of managing personal references for a variety of goals can be electronically managed, thereby making the process easier, more streamlined, faster, more dependable, more accurate, and more secure.

The systems and methods disclosed throughout this application may be implemented on various types of computer architectures including but not limited to: client-server model computer networks, application service provider configurations, one or more general purpose computers or workstations, cloud based and cloud hosted services and data centers, and the like. The systems and methods disclosed throughout this application typically comprise data transmission modalities such as the communication connections 115 and 150. The data transmission modalities may connect any of the computers and/or networks thereof, mobile devices (including phones, tablets, hybrids, embedded devices, or machine-to-machine devices and systems), processors, and storage devices to each other and required by the system and/or processor. Such data transmission modalities may include but are not limited to: local area networks, wide area networks, the internet and connections of such networks thereof, fiber-optic data lines, carrier waves, wireless networks, cellular data networks, and the like.

The systems and methods disclosed throughout this disclosure may comprise tools and processors for: data mining, data analytics, and/or data visualization.

The systems and methods disclosed throughout this application may comprise computer readable media, the computer readable media containing instructions therein readable by and to be carried out by the processor. The computer readable media may contain software adapted to be installed on the various computing devices (computers, mobile devices, servers) of the disclosed systems and methods thereby providing the instructions to be carried out by the processor or any other processor(s) belonging to said various computing devices. The computer readable media may be implemented by various means and formats known in the art including but not limited to optical data media such as CD-ROM, DVD-ROM, and the like, one or more computer hard drives, RAM, flash memory, magnetic tape, and/or holographic storage. The computer readable media may comprise a part of the data storage unit 110. The computer readable media may comprise auxiliary data storage units (not shown) found in any of the computing devices utilized by the disclosed systems and methods, such as RAM and hard drives found in the Participant's computers and/or mobile devices 130, 135, or 140, or the servers 120 and 125 used to facilitate communication between the processor and the Participant's computers and/or mobile devices. The computer readable media may be located in a cloud computing system allowing access, via the internet or a cloud computing network, to and/or installation therefrom by the processor or the other computing devices of the disclosed systems and methods.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the invention and that methods and structures within the scope of these claims and their equivalents be covered thereby.

What is claimed is:

1. A computer-implemented method for managing the giving and receiving and disseminating of personal references and related information, the method comprising:
(a) receiving personal information data from a first user;
(b) forwarding at least a portion of the received data from the first user to a second user;
(c) receiving personal reference information regarding the first user from the second user based on the forwarded data; and
(d) forwarding the received personal reference information to a third user.

2. The method of claim 1, wherein the first user is selected from a group comprising: an individual seeking employment, an individual seeking membership in an organization, an individual seeking enrollment in an educational institution, an individual seeking inclusion or participation in a group of people, an individual seeking a clearance or a type of clearance to qualify for certain jobs or tasks, an individual seeking one or more privileges such as the privilege to apply to a club or to rent an apartment, and an individual or an entity desiring or needing to qualify for or to be favorably considered for certain jobs, projects, or assignments.

3. The method of claim 1, further comprising storing the received personal information data from the first user in a storage device.

4. The method of claim 3, further comprising comparing the personal information data against a rule or permission and allowing the first user to access the stored data based on the compared personal information data.

5. The method of claim 1, further comprising collecting publicly available personal information regarding the first user through the Internet, an Intranet, or other wide-area network.

6. The method of claim 1, wherein the second user comprises an individual for providing a reference or a confirmation regarding the first user.

7. The method of claim 1, wherein forwarding at least a portion of the received data from the first user to the second user comprises allowing the second user to complete an electronic questionnaire for the second user to evaluate the first user.

8. The method of claim 1, further comprising storing the received personal reference information regarding the first user from the second user in a storage device.

9. The method of claim 8, further comprising allowing the second user to set a rule or permission for allowing the first user to access the stored personal reference information.

10. The method of claim 1, wherein the third user is selected from a group comprising an individual, a corporation, an institution, and an organization to whom the first user is providing personal reference information.

11. The method of claim 1, further comprising storing the received personal reference information regarding the first user in a storage device.

12. The method of claim 11, wherein forwarding the received personal reference information to the third user comprises providing the third user at least one of a link, a URL, an access code, a mobile telecommunications application, or a means of access to stored personal information.

13. The method of claim 12, further comprising allowing the third user to at least one of access, modify, or append the stored personal information.

14. The method of claim 13, further comprising notifying the first user when the third user has at least one of accessed, modified, or appended the stored personal information.

15. The method of claim 13, wherein allowing the third user to at least one of access, modify, or append the stored personal information is based on a rule or permission.

16. The method of claim 1, further comprising receiving an interview request from the third user based on the forwarded personal reference information and forwarding the interview request to the second user.

17. A system for performing the method of claim 1, the system comprising a processor configured to perform at least one of steps (a), (b), (c), and (d) and one or more storage devices accessible by the processor.
